(19) United States
(12) Patent Application Publication
(10) Pub. No.: US 2011/0226364 A1
(43) Pub. Date: Sep. 22, 2011

(54) Control Spool for Spool Valves and Method for the Production Thereof

(75) Inventors: Ronald Höll, Hammelburg (DE); Thomas Schlottner, Seligenstadt (DE); Hans-Georg Schubert, Partenstein (DE); Manfred Breckner, Lohr (DE)

(73) Assignee: ROBERT BOSCH GMBH, Stuttgart (DE)

(21) Appl. No.: 13/058,638

(22) PCT Filed: Jul. 20, 2009
(86) PCT No.: PCT/EP2009/005249

§ 371 Date: Jun. 8, 2011

(30) Foreign Application Priority Data
Aug. 13, 2008 (DE) 10 2008 038 971.4

(51) Int. Cl. F15D 1/00; B21K 1/20

(52) U.S. Cl. 137/625.69; 29/890.124

(57) ABSTRACT

A control spool for spool valves includes a tube having an outer circumference, and one or more rings and/or sleeves positioned on the outer circumference of the tube. The one or more rings and/or sleeves each defines at least one circumferential edge that forms at least one control edge.

The invention relates to control spools for spool valves as claimed in patent claim 1 and to a method for the production thereof as claimed in patent claim 9.

As a rule, control spools for spool valves are rotationally symmetrical parts which are machined (turned) from solid according to the prior art. After that, the entire spool is hardened or hardened and tempered.

A disadvantage with such control spools is their high weight, and the high material consumption and the high machining costs during their production are disadvantageous. Furthermore, the hardening and tempering of the entire spool involves high costs.

Against this background, the object of the invention is to provide a lightweight control spool for spool valves. Furthermore, a method for producing control spools is to be provided, in which method the amount of raw material required and the costs for the machining and the hardening and tempering are reduced.

These objects are achieved by a control spool for spool valves having the features of patent claim 1 and by a method for the production thereof having the features of patent claim 9.

The control spool according to the invention has a tube and one or more rings and/or sleeves which are put onto the outer circumference of the tube and the circumferential edges of which form control edges of the spool. The weight of the spool is reduced by the tube. In addition, flexible and simple modular production of various spools, e.g. for different valve circuit diagrams and if need be for different nominal sizes, is possible.

The rings and/or sleeves of the control spool are advantageously connected to the tube in a frictional, positive-locking and/or integral manner. In an especially preferred embodiment, the rings and sleeves are fastened to the tube by internal high-pressure joining. This ensures a permanent connection between the individual components of the spool at a low cost.

In a preferred embodiment variant of the control spool, the tube has bulges in the regions adjacent to the end sections of the rings and sleeves. As a result, the rings and sleeves are fixed axially on the tube.

It is preferred if the rings and sleeves are hardened and tempered in order to increase their strength and therefore ensure reliable functioning of the spool in a valve bore.

In preferred embodiment variants of the control spool, springs, exciters, coils or magnets are accommodated, as alternatives or in combination, in the interior of the tube, wherein these components plunge at least partly into the end-side end sections of the tube. As a result, construction space can be saved and the size of the spool valve can be reduced. Furthermore, the interior of the tube can form part of a pressure medium flow path, as a result of which a tank link, for example, of the valve can be dispensed with.

In a preferred development of the control spool, the rings and/or sleeves have control notches, with which precision control of the valve is possible, e.g. if the valve is a proportional valve.

The rings and/or sleeves are advantageously produced and positioned with an accuracy of at least 5/10 mm (e.g. about 5/100 mm). Reliable functioning of the valve in which the spool according to the invention is used is thus ensured.

The method according to the invention for producing control spools for spool valves comprises the steps:
producing a tube,
producing rings and/or sleeves and
fastening the rings and sleeves to the outer circumference of the tube.

Raw material is saved by this method, and the costs for the machining and the hardening and tempering are reduced. In this case, flexible and simple modular production of various spools, e.g. having an identical inside or tube diameter for different valve bore diameters, is possible. To this end, identical tube sections are provided with different rings and sleeves.

Fastening of the rings and sleeves to the outer circumference of the tube by an interference fit and/or a positive-locking fit is especially preferred, wherein the fastening is effected by applying a high internal pressure to the tube or the interference fit is produced by shrink fitting the rings and sleeves. A permanent connection between the individual components of the spool is thereby ensured.

Alternatively, the rings and sleeves can also be fastened to the outer circumference of the tube by welding or adhesive bonding.

In a preferred further development of the method, the rings and sleeves are hardened and tempered before they are fastened to the tube. As a result, hardening and tempering of the tube can be dispensed with, since said tube is not subjected to any wear.

It is preferred if finish machining (e.g. grinding) of the spool is carried out after the rings and sleeves have been fastened to the outer circumference of the tube. In this way, the requisite accuracy or dimensional stability of the spool can be produced.

Various exemplary embodiments of the invention are described in detail below with reference to the figures. In the drawing:

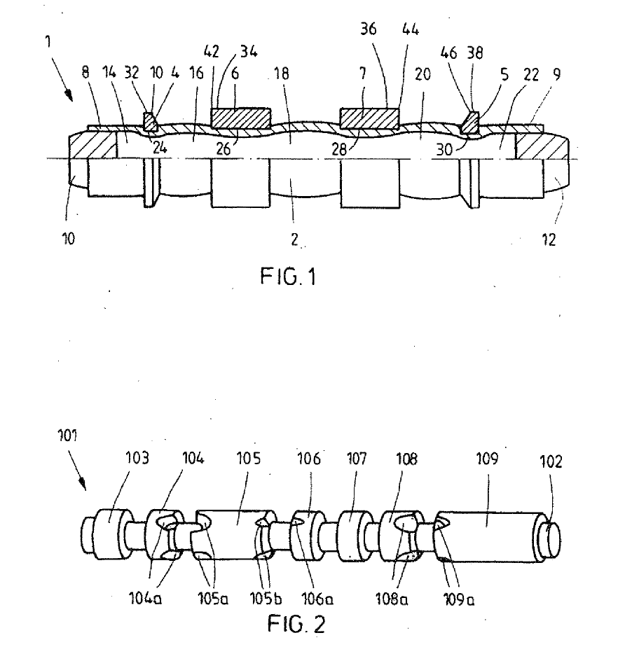

FIG. 1 shows a first exemplary embodiment of a control spool according to the invention in a partly sectioned side view; and

FIG. 2 shows a second exemplary embodiment of a control spool according to the invention in a side view.

FIG. 1 shows a first exemplary embodiment of the control spool 1 according to the invention, the top section thereof in FIG. 1 being shown in a longitudinal section and the bottom section thereof in FIG. 1 being shown in a side view.

The control spool 1, which in the form shown is preferably used in industrial hydraulics, substantially comprises a tube 2 and, in this exemplary embodiment, two rings 4, 5 and two sleeves 6, 7 which are fastened to the outer circumference of the tube 2. Furthermore, displacement limiters 10, 12 are fastened to opposite end sections 8, 9 of the tube 2.

As can be seen in particular in the sectional view of the control spool 1, the tube 2 has sections of increased diameter 14, 16, 18, 20, 22 which respectively adjoin the rings 4, 5 and the sleeves 6, 7 and in which the inside and outside diameters are increased relative to the other sections of the tube 2. Between these sections of increased diameter 14, 16, 18, 20, 22, grooves 24, 26, 28, 30 in which the rings 4, 5 and the sleeves 6, 7 are accommodated in a positive-locking manner are formed on the outer circumference of the tube 2.

The inside diameters of the rings 4, 5 and sleeves 6, 7 are identical and correspond to the diameters of the grooves 24, 26, 28, 30, whereas the outside diameters of the rings 4, 5 and sleeves 6, 7 are predetermined by the diameters of a valve bore of a spool valve (not shown).

Marginal sections of the outer lateral surfaces of the rings 4, 5 and sleeves 6, 7 form control collars 32, 34, 36, 38, whereas control edges 40, 42, 44, 46 of the control spool 1 according to the invention are formed on circumferential edges of the rings 4, 5 and sleeves 6, 7.

During the production of the control spool 1 according to the invention, first of all the tube 2, the rings 4, 5 and the sleeves 6, 7 are produced, the outer circumference of the tube 2, which to begin with is circular-cylindrical, corresponding to the inside diameters of the rings 4, 5 and sleeves 6, 7.

In the next method step, the rings 4, 5 and the sleeves 6, 7 are pushed onto the tube 2 and positioned. A high internal pressure is then applied to the tube 2, as a result of which said tube 2 is opened out slightly at sections 24, 26, 28, which are enclosed by rings 4, 5 or sleeves 6, 7 and is opened out further at sections 14, 16, 18, 20, 22 which are not enclosed by rings 4, 5 or sleeves 6, 7. Grooves 24, 26, 28, 30 therefore remain at the outer circumference of the tube 2, the diameters of said grooves being only marginally larger than the outside diameter of the original tube 2.

The rings 4, 5 and sleeves 6, 7 are accommodated in these grooves 24, 26, 28, 30 in a frictional manner over their respective inner circumferential sections and in a positive-locking manner over their respective end faces.

At the end sections 8, 9 of the tube 2, displacement limiters 10, 12 are inserted partly into the tube 2, as a result of which predetermined stop positions of the control spool 1 can be produced in its axial direction during operation of the valve.

FIG. 2 shows a second exemplary embodiment of a control spool 101 according to the invention, this control spool 101 preferably being used in mobile hydraulics. The control spool 101 has a substantially circular-cylindrical tube 102, and various sleeves 103, 104, 105, 106, 107, 108, 109 are put onto said tube 102. The sleeves 104, 105, 106, 108, 109 each have, at end faces, three precision control notches 104a, 105a, 105b, 106a, 108a, 109a, which are distributed over the circumference and of which two each are depicted. The notches 109a of the sleeve 109, in contrast to the other notches 104a, 105a, 105b, 106a, 108a, do not extend over the entire end face of the sleeve 109.

The precision control notches 104a, 105a, 105b, 106a, 108a, 109a on the sleeves 103, 104, 105, 106, 107, 108, 109 are produced before or after the sleeves 103, 104, 105, 106, 107, 108, 109 are put onto the tube 102.

In contrast to the first exemplary embodiment in FIG. 1, the sleeves 103, 104, 105, 106, 107, 108, 109 of the second exemplary embodiment are fastened to the tube 102 solely by an interference fit. The interference fit is produced, when the control spool 101 is being produced according to the invention, by slipping on the heated sleeves 103, 104, 105, 106, 107, 108, 109 and by cooling them (shrink fitting) after they have been positioned on the tube 102.

In the exemplary embodiments of the control spool 1; 101 according to the invention that are shown in FIGS. 1 and 2, the rings 4, 5 and sleeves 6, 7; 103, 104, 105, 106, 107, 108, 109 are ground after they have been fastened, such that an accuracy or dimensional stability of about 5/100 mm is achieved.

According to the invention, it is preferred if the rings 4, 5 and sleeves 6, 7; 103, 104, 105, 106, 107, 108, 109 are hardened and tempered before being put onto the tube 2; 102, as a result of which the production costs can be reduced. In deviation therefrom, hardening and tempering of the already assembled control spools 1; 101 before or after precision grinding is also possible.

Unlike in the two exemplary embodiments shown in FIGS. 1 and 2, the rings 4, 5 and sleeves 6, 7; 103, 104, 105, 106, 107, 108, 109 can also be fastened to the tube 2; 102 by welding or adhesive bonding.

In deviation from the exemplary embodiments of the control spool according to the invention that are shown, other rings and sleeves, in particular having other dimensions and in a different number, can also be fastened to the tube. Furthermore, springs, exciters, coils or magnets can also be arranged on the end sections of the tube instead of displacement limiters, wherein said springs, exciters, coils or magnets, for space-saving reasons, can plunge entirely or partly into the end sections of the tube.

Disclosed is a control spool for spool valves, comprising a tube and one or more rings and/or sleeves which are put onto the outer circumference of the tube and the circumferential edges of which form control edges of the spool.

In this case, the rings and sleeves of the control spool can be connected to the tube in a frictional, positive-locking and/or integral manner. In a preferred embodiment, the rings and sleeves are fastened to the tube by internal high-pressure joining.

### REFERENCE NUMERALS

1; 101 Control spool
2; 102 Tube
4, 5 Ring
6, 7; 103, 104, 105, 106, 107, 108, 109 Sleeve
8, 9 End section
10, 12 Displacement limiter
14, 16, 18, 20, 22 Section of increased diameter
24, 26, 28, 30 Groove
32, 34, 36, 38 Control collar
40, 42, 44, 46 Control edge
104a, 105a, 105b, 106a, 108a, 109a Precision control notch

1. A control spool for spool valves, comprising:
a tube having an outer circumference; and
one or more rings and/or sleeves positioned on the outer circumference of the tube, wherein the one or more rings and/or sleeves each defines at least one circumferential edge that forms at least one control edge.

2. The control spool for spool valves as claimed in claim 1, wherein the rings and/or sleeves are connected to the tube in a frictional, positive-locking and/or integral manner.

3. The control spool for spool valves as claimed in claim 1, wherein the rings and/or sleeves are fastened to the tube by internal high-pressure joining.

4. The control spool for spool valves as claimed in claim 1, wherein each of the rings and/or sleeves includes end sections, and wherein the tube has bulges in the regions adjacent to the end sections of the rings and/or sleeves, said bulges being configured to axially fix the rings and/or sleeves to the tube.

5. The control spool for spool valves as claimed in claim 1, wherein the rings and/or sleeves are hardened and tempered.

6. The control spool for spool valves as claimed in claim 1, wherein at least one of springs, exciters, coils, magnets, and displacement limiters are at least partially positioned in the interior of the tube.

7. The control spool for spool valves according to claim 1, wherein the rings and/or sleeves have control notches defined therein.

8. The control spool for spool valves according to claim 1, wherein the rings and/or sleeves are produced and positioned with an accuracy of at least 5/10 mm.

9. A method for producing control spools for spool valves, comprising:
producing a tube;
producing rings and/or sleeves; and
fastening the rings and/or sleeves to the outer circumference of the tube.

10. The method for producing control spools for spool valves as claimed in claim 9, wherein the fastening step includes attaching the rings and/or sleeves to the outer circumference of the tube in an interference fit and/or a positive-locking fit manner.

11. The method for producing control spools for spool valves as claimed in claim 9, wherein the fastening step includes attaching the rings and/or sleeves to the outer circumference of the tube by applying a high internal pressure to the tube while the rings and/or sleeves are positioned around the tube.

12. The method for producing control spools for spool valves as claimed in claim 9, wherein the fastening step includes shrink fitting the rings and/or sleeves onto the outer circumference of the tube so as to produce an interference fit connection between the rings and/or sleeves and the tube.

13. The method for producing control spools for spool valves as claimed in claim 9, wherein the fastening step includes welding the rings and/or sleeves to the outer circumference of the tube.

14. The method for producing control spools for spool valves as claimed in claim 9, wherein the step of producing rings and/or sleeves includes the step of pre-hardening the rings and/or sleeves.

15. The method for producing control spools for spool valves as claimed in claim 9, wherein the step of producing rings and/or sleeves includes the step of finish machining the rings and/or sleeves after the fastening step.

16. The control spool for spool valves as claimed in claim 1, wherein:
the tube defines an interior space, and
the interior space forms part of a pressure medium flow path.

17. The method for producing control spools for spool valves as claimed in claim 9, wherein the fastening step includes adhesively bonding the rings and/or sleeves to the outer circumference of the tube.

18. The method for producing control spools for spool valves as claimed in claim 9, wherein the step of producing rings and/or sleeves includes the step of tempering the rings and/or sleeves.

19. The control spool for spool valves according to claim 1, wherein the rings and/or sleeves are produced and positioned with an accuracy of at least about 5/100 mm.
